(19) United States
(12) Patent Application Publication
(10) Pub. No.: US 2023/0041865 A1
(43) Pub. Date: Feb. 9, 2023

(54) ROMAN SHADE

(71) Applicant: Yung-Ching LAI, Chia Yi County (TW)

(72) Inventor: Yung-Ching LAI, Chia Yi County (TW)

(21) Appl. No.: 17/396,024

(22) Filed: Aug. 6, 2021

(51) Int. Cl. E06B 9/262

(52) U.S. Cl. CPC E06B 9/262; E06B 2009/2622

(57) ABSTRACT

A roman shade has a frame, a blind detachably mounted on the frame, a retraction device mounted on the frame, a rolling member, and two guiding members. The rolling member is retractably mounted on the retraction device and has a rolling tape. A bottom end of the rolling tape is free without being connected to the blind. The guiding members are mounted on the retraction device and are located beside two sides of the rolling member. Each guiding member has a guiding tape retractably mounted on the retraction device and a connecting element. The connecting element is mounted on a bottom end of the guiding tape and is connected to the blind. The guiding tape is detachably connected to the blind through the connecting element. It is convenient to detach the blind for cleaning the blind.

### BACKGROUND OF THE INVENTION

### 1. Field of the Invention

The present invention relates to a roman shade, and more particularly to a roman shade that is easy to be detached for cleaning.

### 2. Description of Related Art

With reference to FIG. 13, a conventional roman shade has a frame 90, a blind 91, a retraction device 92, a rolling shade 93, a tape 94, and a handle 95. The frame 90 is mounted on a ceiling. The blind 91 is mounted on a front surface of the frame 90. The retraction device 92 is mounted between two wings 96 of the frame 90. A top end of the rolling shade 93 is fixed on the retraction device 92. A bottom end of the rolling shade 93 is sewed on an inner surface of the blind 91. The tape 94 is fixedly mounted on the rolling shade 93 adjacent to the blind 91. The handle 95 is mounted on a bottom end of the tape 94.

In a folding operation, the rolling shade 93 is driven by and wound on the retraction device 92. The bottom end of the rolling shade 93 moves upwardly and drives the blind 91 to move upwardly.

In an unfolding operation, the handle 95 can be pulled downwardly by a user for driving the bottom end of the rolling shade 93 to move downwardly through the tape 94. The bottom end of the rolling shade 93 is sewed on the inner surface of the blind 91 and moves downwardly, so that the blind 91 is expanded through the rolling shade 93.

The bottom end of the rolling shade 93 is sewed and fixed on the inner surface of the blind 91. It is inconvenient to detach the blind 91 from the rolling shade 93 for cleaning.

Furthermore, another conventional roman shade replaces the said rolling shade 93 with two rolling tapes. Top ends of the two rolling tapes are fixed on the retraction device. Bottom ends of the two rolling tapes are sewed on an inner surface of the blind. Therefore, it is inconvenient to detach the blind from the two rolling tapes for cleaning.

To overcome the shortcomings, the present invention provides a roman shade to mitigate or obviate the aforementioned problems.

### SUMMARY OF THE INVENTION

The objective of the invention is to provide a roman shade that can solve the shortcoming that a detachment operation of the blind of the conventional roman shade is inconvenient for cleaning.

The roman shade of the present invention has a frame, a blind, a retraction device, a rolling member, and multiple guiding members. The frame has two wings mounted at a spaced interval. The blind is detachably mounted on a front surface of the frame. The retraction device is mounted between the two wings of the frame. The rolling member is mounted on the retraction device and has a rolling tape and a handle. The rolling tape is retractably mounted on the retraction device and is adjacent to an inner surface of the blind. The handle is mounted on a bottom end of the rolling tape. A top end of the rolling tape is fixed on the retraction device. The bottom end of the rolling tape is free without being connected to the blind. The guiding members are mounted on the retraction device at a spaced interval and are located beside two sides of the rolling member. Each one of the guiding members has a guiding tape and a connecting element. The guiding tape is retractably mounted on the retraction device and is adjacent to the inner surface of the blind. The connecting element is mounted on a bottom end of the guiding tape and is connected to the blind. The guiding tape is detachably connected to the blind through the connecting element.

In a folding operation, the rolling tape driven by the retraction device is wound on the retraction device. The two guiding tapes are driven by the retraction device, are wound on the retraction device, and pull the blind by the two connecting elements. In an unfolding operation, the handle can be pulled downwardly by a user, and the rolling tape extends downwardly for driving the two guiding tapes to extend downwardly through the retraction device. The multiple guiding members simultaneously drive the blind to extend downwardly.

In a cleaning operation, the two guiding tapes are detachably connected to the blind through the two connecting elements, and the bottom end of the rolling tape is free without being connected to the blind. Therefore, it is convenient to detach the blind for cleaning or changing the blind.

Other objectives, advantages and novel features of the invention will become more apparent from the following detailed description when taken in conjunction with the accompanying drawings.

### BRIEF DESCRIPTION OF THE DRAWINGS

FIG. 1 is a front side view of a first embodiment of a roman shade in accordance with the present invention;

FIG. 2 is a rear side view of the roman shade in FIG. 1;

FIG. 3 is an enlarged rear side view of the roman shade in FIG. 1;

FIG. 4 is a cross sectional side view of the roman shade along line 4-4 in FIG. 3;

FIG. 5 is a front side view of a second embodiment of a roman shade in accordance with the present invention;

FIG. 6 is a rear side view of the roman shade in FIG. 5;

FIG. 7 is an enlarged rear side view of the roman shade in FIG. 5;

FIG. 8 is a cross sectional side view of the roman shade along line 8-8 in FIG. 7;

FIG. 9 is a cross sectional side view of the roman shade along line 9-9 in FIG. 7;

FIG. 10 is a folding operational rear side view of the roman shade in FIG. 5;

FIG. 11 is an enlarged rear side view of a third embodiment of a roman shade in accordance with the present invention;

FIG. 12 is a cross sectional side view of the roman shade along line 12-12 in FIG. 11; and

FIG. 13 is a rear side view of a conventional roman shade in accordance with the prior art.

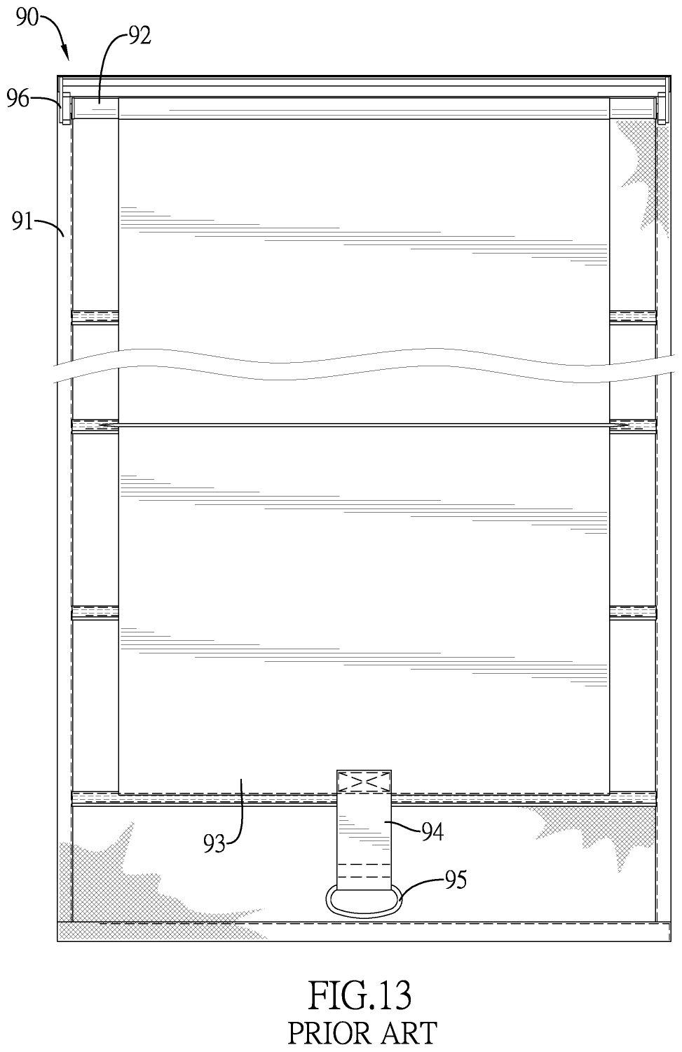

### DETAILED DESCRIPTION OF THE PREFERRED EMBODIMENT

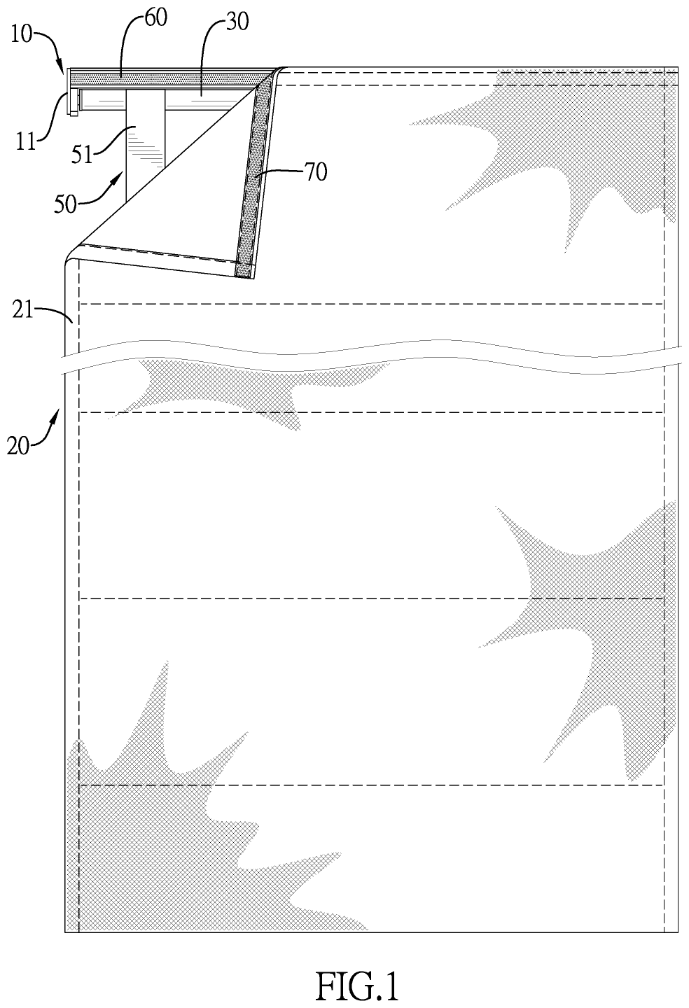

With reference to FIGS. 1, 2, 5, and 6, a roman shade in accordance with the present invention has a frame 10, a blind 20, 20′, a retraction device 30, a rolling member 40, and multiple guiding members 50.

The frame 10 is mounted on a ceiling or a wall. The frame 10 has two wings 11 mounted at a spaced interval.

The blind 20, 20′ is detachably mounted on a front surface of the frame 10 and is used to shelter.

The retraction device 30 is mounted between the two wings 11 of the frame 10.

The rolling member 40 is mounted on the retraction device 30 and has a rolling tape 41 and a handle 42. The rolling tape 41 is retractably mounted on the retraction device 30 and is adjacent to an inner surface of the blind 20, 20′. The handle 42 is mounted on a bottom end of the rolling tape 41. A top end of the rolling tape 41 is fixed on the retraction device 30. The bottom end of the rolling tape 41 is free without being connected to the blind 20, 20′.

The guiding members 50 are mounted on the retraction device 30 at a spaced interval and are located beside two sides of the rolling member 40. Each one of the guiding members 50 has a guiding tape 51 and a connecting element 52. The guiding tape 51 is retractably mounted on the retraction device 30 and is adjacent to the inner surface of the blind 20, 20′. The connecting element 52 is mounted on a bottom end of the guiding tape 51 and is connected to the blind 20, 20′. The guiding tape 51 is detachably connected to the blind 20, 20′ through the connecting element 52.

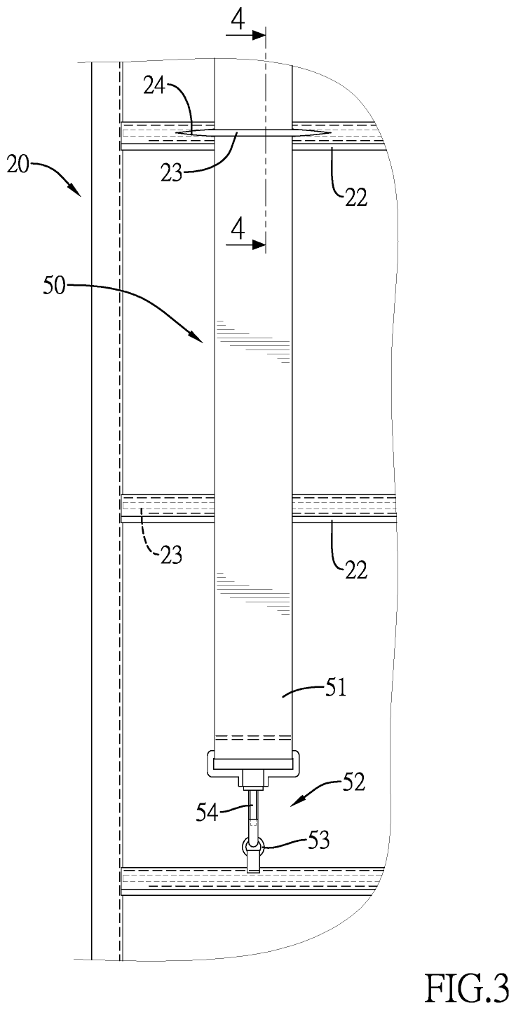

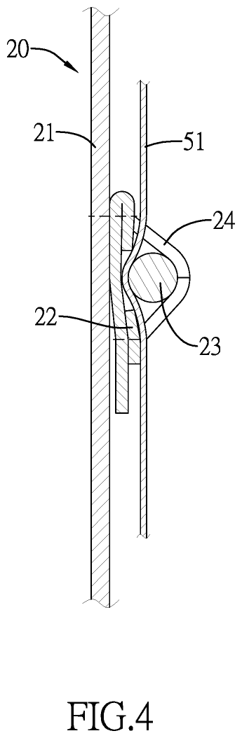

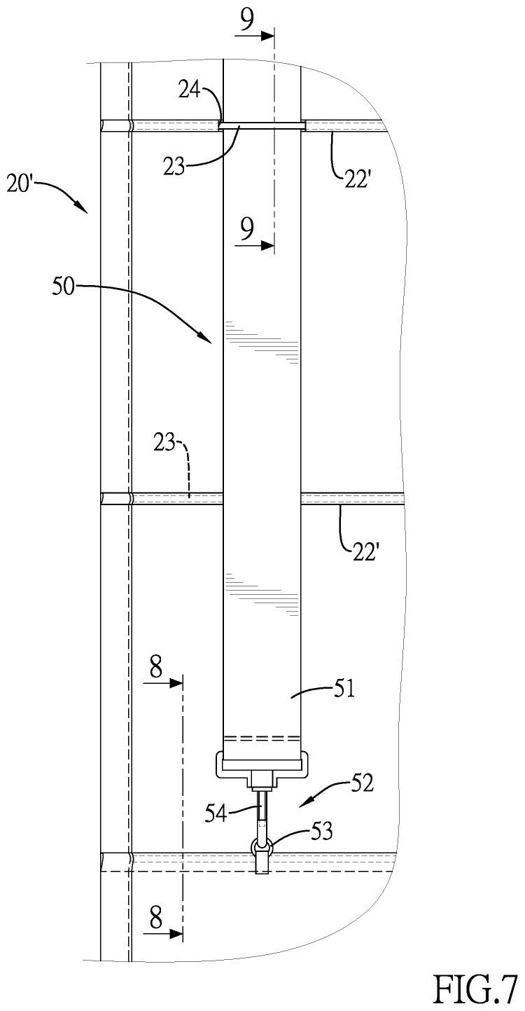

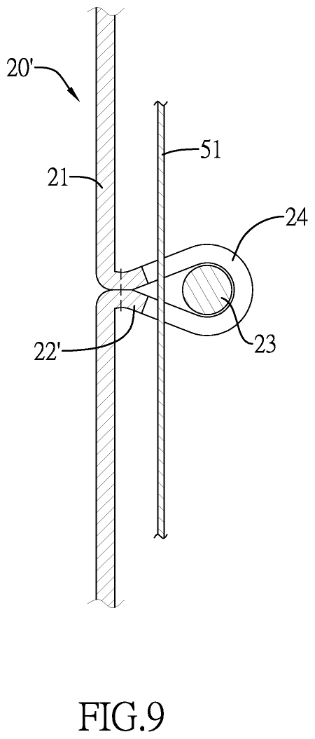

With reference FIGS. 3 and 4, in a first embodiment of the roman shade, the blind 20 has a body 21, multiple sleeve portions 22, and multiple transverse rods 23. The body 21 is detachably mounted on the front surface of the frame 10. The sleeve portions 22 are fixedly mounted on an inner surface of the body 21. Preferably, each one of the sleeve portions 22 extends to two transverse sides of the body 21. Each one of the sleeve portions 22 has multiple notches 24 formed through the sleeve portion 22 at spaced intervals. Preferably, the notches 24 divide the sleeve portion 22 into several sections. The transverse rods 23 are respectively inserted through the sleeve portions 22. The transverse rod 23 is exposed out at the notches 24 of the corresponding sleeve portion 22. The two guiding tapes 51 are inserted through the corresponding notches 24 of the sleeve portions 22 and are located between each one of the corresponding transverse rods 23 and the body 21. With reference to FIGS. 7 and 9, in a second embodiment of the roman shade, the sleeve portions 22′ are integrally formed on the inner surface of the body 21.

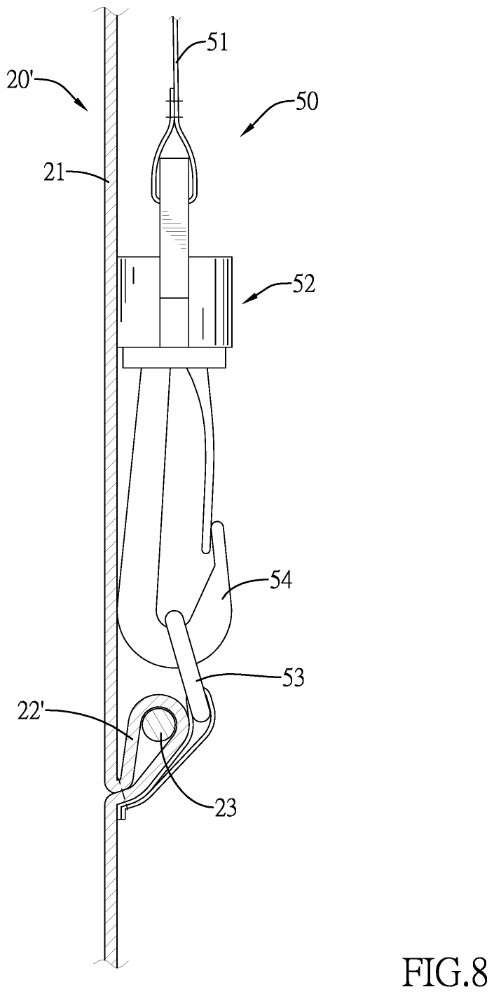

With reference to FIGS. 7 and 8, in each one of the guiding members 50, the connecting element 52 has a ring 53 and a hook 54. The ring 53 is mounted on the inner surface of the blind 20′. The hook 54 is mounted on the bottom end of the guiding tape 51 and detachably hooks the ring 53.

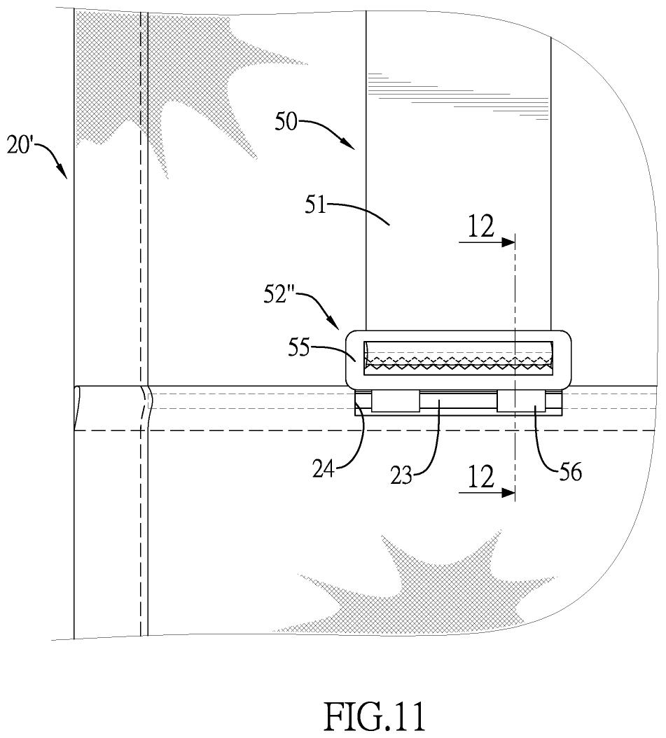

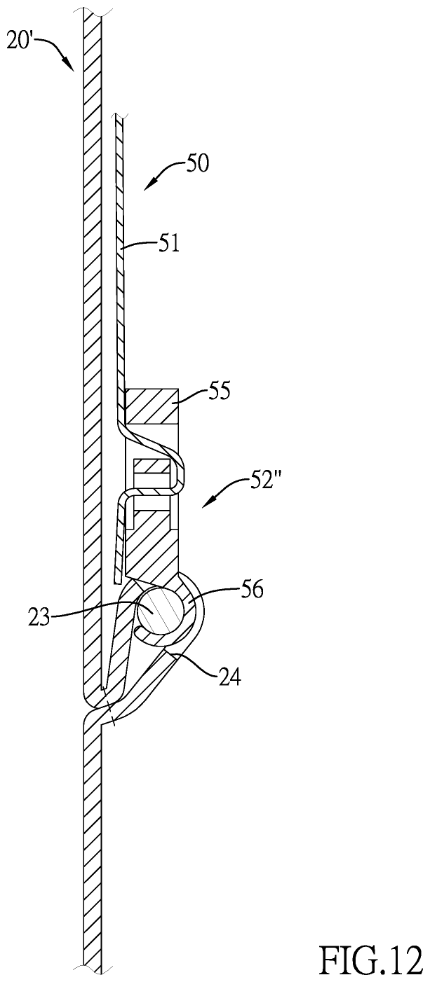

With reference to FIGS. 11 and 12, in a third embodiment of the roman shade, in each one of the guiding members 50, the connecting element 52″ has a plate 55 and a hooking portion 56. The plate 55 is mounted on the bottom end of the guiding tape 51. The hooking portion 56 is formed on the plate 55, is inserted into one of the notches 24, and detachably hooks one of the transverse rods 23.

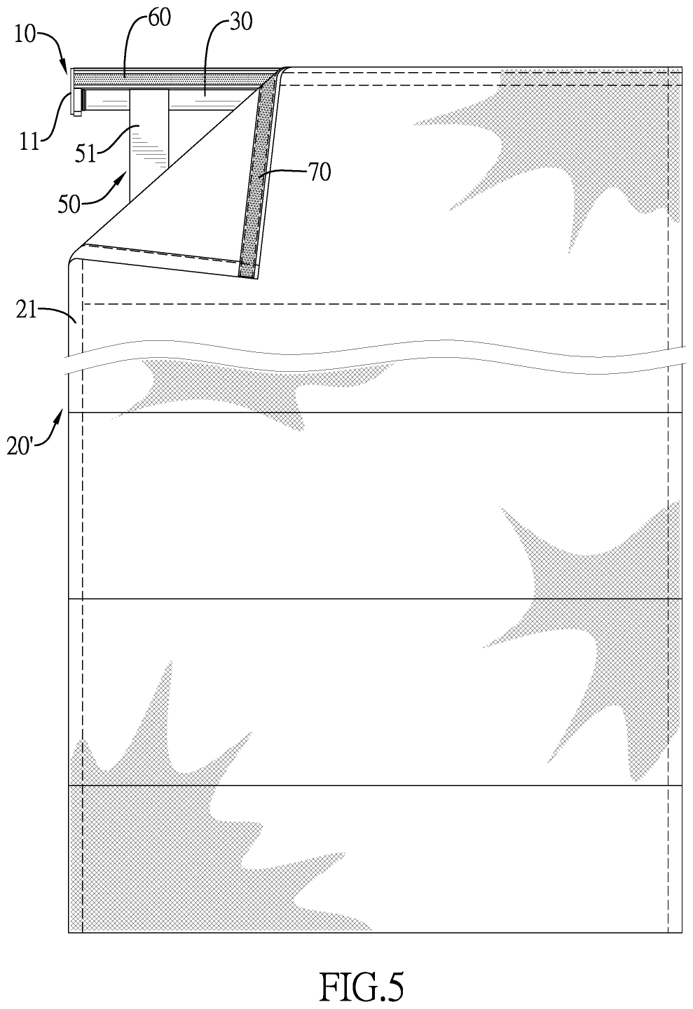

With reference to FIGS. 1 and 5, the roman shade has a first fastener 60 and a second fastener 70. The first fastener 60 is fixedly mounted on the front surface of the frame 10. The second fastener 70 is fixedly mounted on the inner surface of the blind 20, 20′ and is detachably connected to the first fastener 60. The first fastener 60 and the second fastener 70 are preferably adhesive straps.

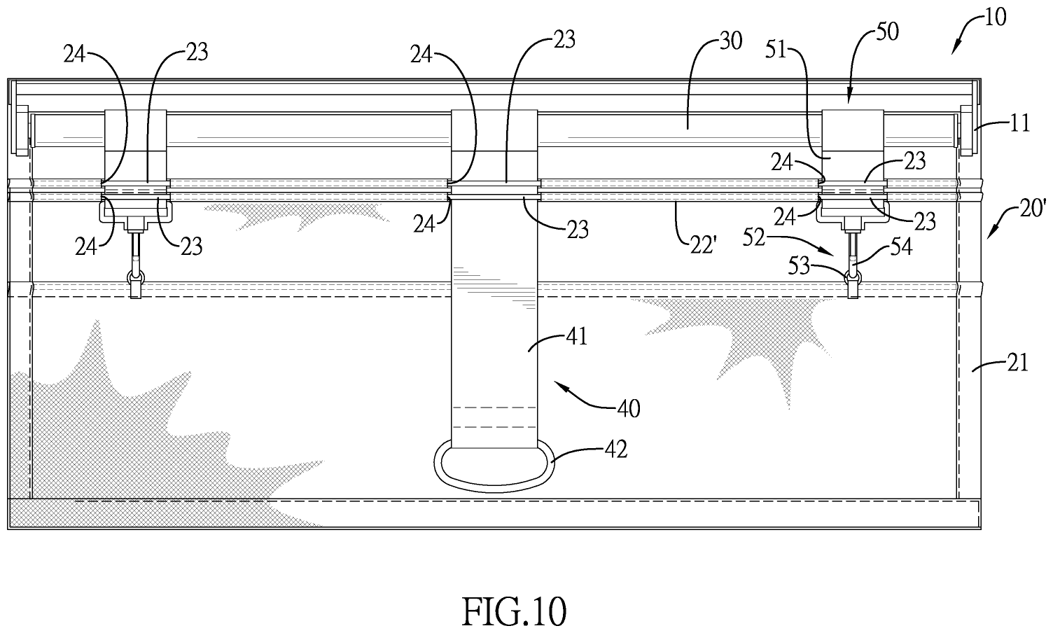

With reference to FIG. 10, in a folding operation, the rolling tape 41 and the two guiding tapes 51 are driven by the retraction device 30 and are wound on the retraction device 30 simultaneously. The two guiding tapes 51 are connected to the blind 20′ through the two connecting elements 52 and can pull the blind 20′ to fold the blind 20′.

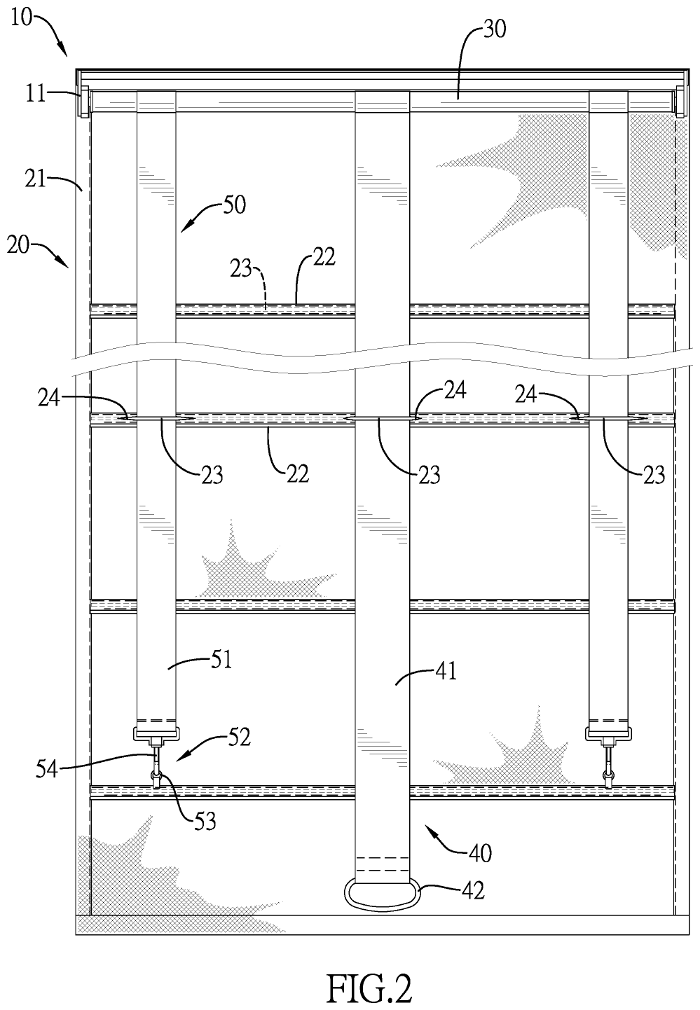

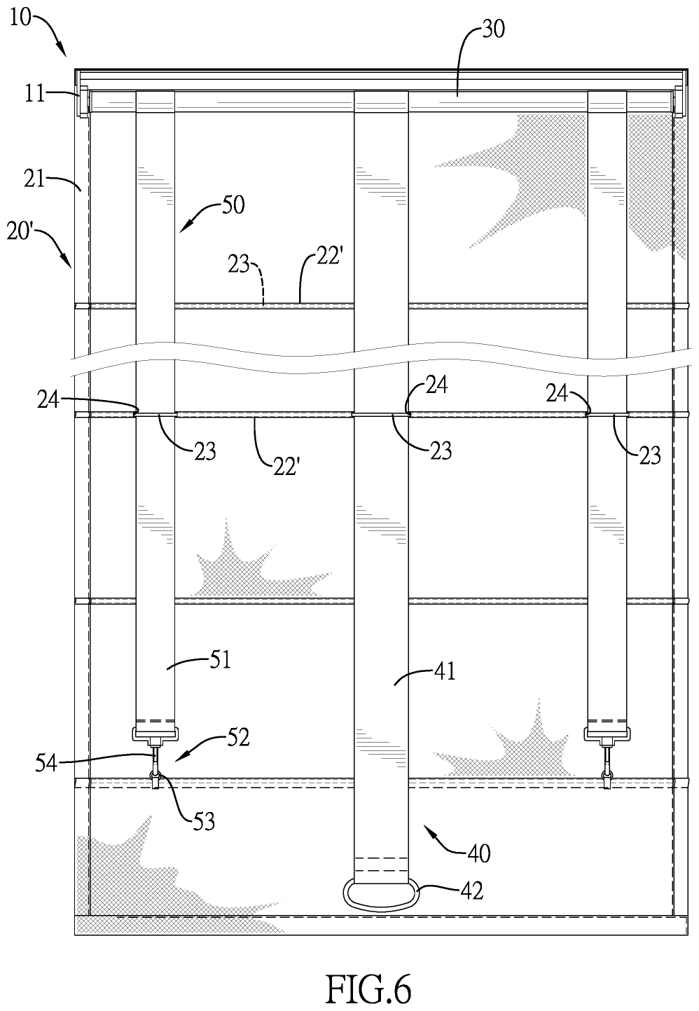

With reference to FIGS. 2 and 6, in an unfolding operation, the handle 42 can be pulled downwardly by a user. The rolling tape 41 extends downwardly for driving the two guiding tapes 51 to extend downwardly through the retraction device 30. The guiding members 50 simultaneously drive the blind 20, 20′ to extend downwardly for sheltering.

With reference to FIGS. 1 and 2, in a cleaning operation, the second fastener 70 is detached from the first fastener 60, such that the blind 20 is detached from the frame 10. In each one of the guiding members 50, the hook 54 can be detached from the ring 53 to release the blind 20. With reference to FIGS. 11 and 12, in each one of the guiding members 50, the hooking portion 56 can be detached from the corresponding one of the transverse rods 23 to release the blind 20′. Therefore, the blind 20, 20′ can be detached from the frame 10 and the guiding members 50 for easily cleaning or changing.

Accordingly, the bottom end of the rolling tape 41 is free without being connected to the blind 20, 20′, and the two guiding tapes 51 are detachably connected to the blind 20, 20′ through the two connecting elements 52, 52″. Detaching the blind 20, 20′ is convenient.

In addition, with reference to FIGS. 7 and 8, in each one of the guiding members 50, a hooking state between the ring 53 and the hook 54 is not tight to provide an adjustment margin for increasing the flatness of the blind 20′.

Similarly, with reference to FIGS. 11 and 12, in each one of the guiding members 50, the guiding tape 51 can be slid relative to the plate 55 to adjust a distance between the hooking portion 56 and the retraction device 30 for increasing the flatness of the blind 20′ or suiting blinds 20′ of different sizes.

What is claimed is:

1. A roman shade comprising:
a frame having two wings mounted at a spaced interval;
a blind detachably mounted on a front surface of the frame;
a retraction device mounted between the two wings of the frame;
a rolling member mounted on the retraction device and having
a rolling tape retractably mounted on the retraction device and adjacent to an inner surface of the blind;
a handle mounted on a bottom end of the rolling tape; and
wherein a top end of the rolling tape is fixed on the retraction device, and the bottom end of the rolling tape is free without being connected to the blind; and
multiple guiding members mounted on the retraction device at spaced intervals and located beside two sides of the rolling member, and each one of the guiding members having
a guiding tape retractably mounted on the retraction device and adjacent to the inner surface of the blind; and
a connecting element mounted on a bottom end of the guiding tape and connected to the blind, wherein the guiding tape is detachably connected to the blind through the connecting element.

2. The roman shade as claimed in claim 1, wherein the blind has
a body detachably mounted on the front surface of the frame;
multiple sleeve portions fixedly mounted on an inner surface of the body and each one of the sleeve portions having
multiple notches formed through the sleeve portion at spaced intervals; and
multiple transverse rods respectively inserted through the sleeve portions.

3. The roman shade as claimed in claim 1, wherein the blind has
a body detachably mounted on the front surface of the frame;
multiple sleeve portions integrally formed on an inner surface of the body and each one of the sleeve portions having
multiple notches formed through the sleeve portion at spaced intervals; and
multiple transverse rods respectively inserted through the sleeve portions.

4. The roman shade as claimed in claim 1, wherein in each one of the guiding members, the connecting element has
a ring mounted on the inner surface of the blind; and
a hook mounted on the bottom end of the guiding tape and detachably hooking the ring.

5. The roman shade as claimed in claim 2, wherein in each one of the guiding members, the connecting element has
a ring mounted on the inner surface of the blind; and
a hook mounted on the bottom end of the guiding tape and detachably hooking the ring.

6. The roman shade as claimed in claim 3, wherein in each one of the guiding members, the connecting element has
a ring mounted on the inner surface of the blind; and
a hook mounted on the bottom end of the guiding tape and detachably hooking the ring.

7. The roman shade as claimed in claim 2, wherein in each one of the guiding members, the connecting element has
a plate mounted on the bottom end of the guiding tape;
a hooking portion formed on the plate, inserted into one of the notches, and detachably hooking one of the transverse rods.

8. The roman shade as claimed in claim 3, wherein in each one of the guiding members, the connecting element has
a plate mounted on the bottom end of the guiding tape;
a hooking portion formed on the plate, inserted into one of the notches, and detachably hooking one of the transverse rods.

9. The roman shade as claimed in claim 1, wherein the roman shade has
a first fastener fixedly mounted on the front surface of the frame; and
a second fastener fixedly mounted on the inner surface of the blind and detachably connected to the first fastener.

10. The roman shade as claimed in claim 2, wherein the roman shade has
a first fastener fixedly mounted on the front surface of the frame; and
a second fastener fixedly mounted on the inner surface of the blind and detachably connected to the first fastener.

11. The roman shade as claimed in claim 3, wherein the roman shade has
a first fastener fixedly mounted on the front surface of the frame; and
a second fastener fixedly mounted on the inner surface of the blind and detachably connected to the first fastener.

12. The roman shade as claimed in claim 4, wherein the roman shade has
a first fastener fixedly mounted on the front surface of the frame; and
a second fastener fixedly mounted on the inner surface of the blind and detachably connected to the first fastener.

13. The roman shade as claimed in claim 5, wherein the roman shade has
a first fastener fixedly mounted on the front surface of the frame; and
a second fastener fixedly mounted on the inner surface of the blind and detachably connected to the first fastener.

14. The roman shade as claimed in claim 6, wherein the roman shade has
a first fastener fixedly mounted on the front surface of the frame; and
a second fastener fixedly mounted on the inner surface of the blind and detachably connected to the first fastener.

15. The roman shade as claimed in claim 7, wherein the roman shade has
a first fastener fixedly mounted on the front surface of the frame; and
a second fastener fixedly mounted on the inner surface of the blind and detachably connected to the first fastener.

16. The roman shade as claimed in claim 8, wherein the roman shade has
a first fastener fixedly mounted on the front surface of the frame; and
a second fastener fixedly mounted on the inner surface of the blind and detachably connected to the first fastener.
